(19) United States
(12) Patent Application Publication
(10) Pub. No.: US 2009/0075813 A1
(43) Pub. Date: Mar. 19, 2009

(54) CATALYST AND METHOD OF MANUFACTURE

(75) Inventors: Donald Wayne Whisenhunt, JR., Niskayuna, NY (US); Dan Hancu, Clifton Park, NY (US); Benjamin Wood, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/173,492

(22) Filed: Jul. 15, 2008

Related U.S. Application Data
(60) Provisional application No. 60/994,448, filed on Sep. 19, 2007.

(51) Int. Cl. B01J 37/00; B01J 29/40; B01J 29/18; B01J 29/08

(52) U.S. Cl. 502/64; 502/60; 502/77; 502/78; 502/79; 502/74; 502/73

(57) ABSTRACT

Disclosed herein is a catalytic composition comprising a first catalyst composition portion that comprises a zeolite; and a second catalyst composition portion that comprises a catalytic metal disposed upon a porous inorganic substrate; the first catalyst composition portion and the second catalyst composition portion being in an intimate mixture. Disclosed herein is a method, comprising mixing a first catalyst composition portion with the second catalyst composition portion to form a catalytic composition; the first catalyst composition portion comprising a zeolite and the second catalyst composition portion comprising a metal disposed upon a porous substrate.

### CROSS-REFERENCE TO RELATED APPLICATIONS

This application claims priority to provisional application 60/994,448 filed on Sep. 19, 2007, the entire contents of which are hereby incorporated by reference.

### BACKGROUND

1. Technical Field

This invention includes embodiments that may relate to catalysts. This invention includes embodiments that may relate to methods of making catalysts. This invention includes embodiments that may relate to articles that include catalysts.

2. Discussion of Art

Exhaust streams generated by the combustion of fossil fuels in, for example, furnaces, ovens, and engines, contains nitrogen oxides (NOx), unburned hydrocarbons (HC), and carbon monoxide (CO), all of which may be undesirable. NOx, though thermodynamically unstable, may not spontaneously decompose in the absence of a catalyst. Exhaust streams may employ exhaust treatment devices to remove NOx from the exhaust stream.

Examples of exhaust treatment devices include: catalytic converters (e.g., three-way catalyst, oxidation catalysts, selective catalytic reduction (SCR) catalysts, and the like), evaporative emissions devices, scrubbing devices (e.g., hydrocarbon (HC), sulfur, and the like), particulate filters/traps, adsorbers/absorbers, plasma reactors (e.g., non-thermal plasma reactors and thermal plasma reactors), and the like. A three-way catalyst (TWC catalyst) in a catalytic converter may reduce NOx by using CO and residual hydrocarbon. TWC catalysts may be effective over a specific operating range of both lean and rich fuel/air conditions and within a specific operating temperature range.

Particulate catalyst compositions may enable optimization of the conversion of HC, CO, and NOx. The conversion rate may depend on the exhaust gas temperature. The catalytic converter may operate at an elevated catalyst temperature of about 300 degrees Celsius or higher. The time period between when the exhaust emissions begin (i.e., “cold start”), until the time when the substrate heats up to a light-off temperature, is the light-off time. Light-off temperature is the catalyst temperature at which fifty percent (50%) of the emissions from the engine convert as they pass through the catalyst.

The exhaust gases from the engine may heat the catalytic converter. This heating may help bring the catalyst to light-off temperature. The exhaust gases pass through the catalytic converter relatively unchanged when the light-off temperature is reached. In addition, the composition of the engine exhaust gas changes as the engine temperature increases from a cold start temperature to an operating temperature, and the TWC catalyst may work with the exhaust gas composition that is present at normal elevated engine operating temperatures.

Selective Catalytic Reduction (SCR) may include a noble metal system, base metal system, or zeolite system. The noble metal catalyst may operate in a temperature regime of from about 240 degrees Celsius to about 270 degrees Celsius, but may be inhibited by the presence of SO₂. The base metal catalysts may operate in a temperature range of from about 310 degrees Celsius to about 400 degrees Celsius, but may promote oxidation of SO₂ to SO₃. The zeolites can withstand temperatures up to 600 degrees Celsius and, when impregnated with a base metal may have a wide range of operating temperatures.

SCR systems with ammonia as a reductant may yield NOx reduction efficiencies of more than 80% in large natural gas fired turbine engines, and in lean burn diesel engines. However, the presence of ammonia may be undesirable, and there may be some ammonia slip due to imperfect distribution of reacting gases.

Selective Catalytic Reduction with hydrocarbons may reduce NOx emissions. NOx can be selectively reduced by some organic compounds (e.g. alkanes, olefins, alcohols) over several catalysts under excess O₂ conditions. The injection of diesel or methanol has been explored in heavy-duty stationary diesel engines to supplement the HCs in the exhaust stream. However, the conversion efficiency may be reduced outside the temperature range of 300 degrees Celsius to 400 degrees Celsius. In addition, this technique may have HC-slippage over the catalyst, transportation and on-site bulk storage of hydrocarbons, and possible atmospheric release of the HC. The partial oxidation of hydrocarbons may release CO, unburned HC, and particulate.

It may be desirable to have a catalyst that can effect emission reduction across a range of temperatures and operating conditions that differ from those currently available. It may desirable to have a catalyst that can effect NOx reduction using a reductant is different than the currently used reductants.

### BRIEF DESCRIPTION

Disclosed herein is a catalytic composition comprising a first catalyst composition portion that comprises a zeolite; and a second catalyst composition portion that comprises a catalytic metal disposed upon a porous inorganic substrate; the first catalyst composition portion and the second catalyst composition portion being in an intimate mixture.

Disclosed herein is a method, comprising mixing a first catalyst composition portion with the second catalyst composition portion to form a catalytic composition; the first catalyst composition portion comprising a zeolite and the second catalyst composition portion comprising a metal disposed upon a porous substrate.

### BRIEF DESCRIPTION OF FIGURES

FIG. 1 is a schematic diagram depicting the furnace set-up during the Example 1 where the composition was placed in a furnace between two plugs of quartz wool;

FIG. 2 is a bar graph that shows NOx conversion at various temperatures in the furnace;

FIG. 3(a) is a schematic diagram depicting the furnace set-up during the Example 1 where the composition was tested by placing a single bed containing the composition between two plugs of quartz wool;

FIG. 3(b) is a schematic diagram depicting the furnace set-up during the Example 2, where the first catalyst composition portion and the second catalyst composition portion was tested in a dual bed configuration; and

FIG. 4 is a bar graph that shows NOx conversion at various temperatures in the furnace.

### DETAILED DESCRIPTION

This invention includes embodiments that may relate to catalysts. This invention includes embodiments that may relate to methods of making catalysts. This invention includes embodiments that may relate to articles that include catalysts. The catalytic composition may chemically reduce NOx that is present in emissions generated during combustion in furnaces, ovens, engines, and locomotives.

In one embodiment, the catalytic composition may include a first catalyst composition portion and a second catalyst composition portion that are mixed together. The first catalyst composition portion and the second catalyst composition portion may be intimately mixed together. The mixed catalytic composition may reduce the NOx present in emissions generated during combustion when in contact therewith. The mixed catalytic composition may reduce a larger amount of NOx in an emissions stream relative to a similar catalytic composition that is not intimately mixed together. The term “intimately” or “intimate” as it relates to the mixing of the first catalyst composition portion and the second catalyst composition portion is intended to mean that a portion of the respective compositions are in particulate form and the particulates are in physical contact with one another.

The first catalyst composition portion includes a zeolite while the second catalyst composition portion includes a catalytic metal disposed upon a porous substrate. The porous substrate includes an inorganic material that can be a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbide, or the like, or a combination including at least one of the foregoing inorganic materials. When the catalytic composition is employed to reduce NOx generated in emissions from furnaces, ovens, locomotives and engines, a variety of hydrocarbons can be effectively used as a reductant. In an exemplary embodiment, diesel can be used as a reductant. The catalytic composition can reduce NOx while using higher hydrocarbons having from about 5 to about 9 carbon atoms per molecule as a reductant. The catalyst advantageously functions across a variety of temperature ranges. Suitable temperature ranges may include temperatures of greater than about 325 degrees Celsius. Other temperatures ranges may include those up to about 400 degrees Celsius.

The first catalyst composition portion may include a zeolite. In one embodiment, the zeolite is metal free, i.e., the zeolite contains no metal ions and is not doped with a metal. The zeolites may be naturally occurring or synthetic. Examples of suitable zeolites are zeolite Y, zeolite beta, ferrierite, mordenite, ZSM-5, or the like, or a combination including at least one of the foregoing zeolites. In one embodiment, the first catalyst composition portion consists essentially of ferrierite.

An exemplary zeolite is a ferrierite having a silicon to aluminum ratio of about 10 to about 30. In one embodiment, the ferrierite has a silicon to aluminum ratio of about 12 to about 15, about 15 to about 17, about 17 to about 20, about 20 to about 23, about 23 to about 25, or greater than about 25.

Examples of commercially available zeolites that may be used in the first catalyst composition portion are marketed under the following trademarks: CBV100, CBV300, CBV400, CBV500, CBV600, CBV712, CBV720, CBV760, CBV780, CBV901, CP814E, CP814C, CP811C-300, CP914, CP914C, CBV2314, CBV3024E, CBV5524G, CBV8014, CBV28014, CBV10A, CBV21A, CBV90A, or the like, or a combination including at least one of the foregoing commercially available zeolites.

An average catalytic composition particle size is less than about 100 nanometers. In one embodiment, the average catalytic composition particle size is in a range of from about 0.1 nanometers to about 1 nanometer, from about 1 nanometer to about 5 nanometers, from about 5 nanometers to about 15 nanometers, from about 15 nanometers to about 25 nanometers, from about 25 nanometers to about 50 nanometers, or greater than about 50 nanometers.

The zeolite particles are in the form of extrudates and generally have an average particle size up to about 1.60 millimeters. In one embodiment, the zeolite particles have an average particle size of about 0.001 millimeters to about 0.1 millimeters, about 0.1 millimeters to about 0.5 millimeters, about 0.5 millimeters to about 0.8 millimeters, about 0.8 millimeters to about 1.1 millimeters, or greater than about 1.1 millimeters. In an exemplary embodiment, the zeolite particles have an average particle size of about 0.001 millimeter.

The zeolite particles may have a surface area of up to about 600 square meters per gram (m²/gm). In one embodiment, the zeolite particles may have a surface area in a range of from about 50 m²/gm to about 100 m²/gm, from about 100 m²/gm to about 200 m²/gm, from about 200 m²/gm to about 300 m²/gm, from about 300 m²/gm to about 400 m²/gm, from about 400 m²/gm to about 500 m²/gm, or greater than about 500 m²/gm.

The first catalyst composition portion may be present in an amount of up to about 80 wt %, based upon the total weight of the catalytic composition. In one embodiment, the first catalyst composition portion may be present in an amount in a range of from about 20 wt % to about 30 wt %, from about 30 wt % to about 40 wt %, from about 40 wt % to about 50 wt %, from about 50 wt % to about 60 wt %, from about 60 wt % to about 70 wt %, or greater than about 70 wt %, based upon the total weight of the catalytic composition.

As noted above, the second catalyst composition portion includes a metal disposed upon a porous substrate. The porous substrate is an inorganic material that can be a metal oxide, an inorganic oxide, an inorganic carbide, an inorganic nitride, an inorganic hydroxide, an inorganic oxide having a hydroxide coating, an inorganic carbonitride, an inorganic oxynitride, an inorganic boride, an inorganic borocarbides, or the like, or a combination including at least one of the foregoing inorganic materials. In one embodiment, the porous substrate consists essentially of a metal oxide or an inorganic oxide.

Examples of suitable inorganic oxides include silica (SiO₂), alumina (Al₂O₃), titania (TiO₂), zirconia (ZrO₂), ceria (CeO₂), manganese oxide (MnO₂), zinc oxide (ZnO), iron oxides (e.g., FeO, β-Fe₂O₃, γ-Fe₂O₃, ε-Fe₂O₃, Fe₃O₄, or the like), calcium oxide (CaO), manganese dioxide (MnO₂ and Mn₃O₄), or combinations including at least one of the foregoing inorganic oxides. Examples of inorganic carbides include silicon carbide (SiC), titanium carbide (TiC), tantalum carbide (TaC), tungsten carbide (WC), hafnium carbide (HfC), or the like, or a combination including at least one of the foregoing carbides. Examples of suitable nitrides include silicon nitrides (Si₃N₄), titanium nitride (TiN), or the like, or a combination including at least one of the foregoing. Examples of suitable borides are lanthanum boride (LaB₆), chromium borides (CrB and CrB₂), molybdenum borides (MoB₂, Mo₂B₅ and MoB), tungsten boride (W₂B₅), or the like, or combinations including at least one of the foregoing borides. In one embodiment, the porous substrate consists essentially of alumina.

The porous substrate may have a surface area of up to about 2,000 square meter per gram (m²/gm). In one embodiment, the porous substrate may have a surface area in a range of from about 20 m²/gm to about 100 m²/gm, from about 100 m²/gm to about 200 m²/gm, from about 200 m²/gm to about 400 m²/gm, from about 400 m²/gm to about 600 m²/gm, from about 600 m²/gm to about 800 m²/gm, from about 800 m²/gm to about 1,000 m²/gm, from about 1,000 m²/gm to about 1,200 m²/gm, from about 1,200 m²/gm to about 1,600 m²/gm, or greater than about 1,600 m²/gm.

The porous substrate may be in the form of particles. The particles may be agglomerates, a sintered mass, a surface coating on a support, or the like. The porous substrate may have an average particle size of up to about 4 millimeters. In one embodiment, the porous inorganic materials may have an average particle in a range of from about 5 micrometers to about 50 micrometers, from about 50 micrometers to about 100 micrometers, from about 100 micrometers to about 500 micrometers, from about 500 micrometers to about 1 millimeter, from about 1 millimeter to about 2 millimeters, from about 2 millimeters to about 3 millimeters, or greater than about 3 millimeters. In an exemplary embodiment, the porous substrate has an average particle size of about 40 micrometers.

The catalytic metal may include alkali metals, alkaline earth metals, transition metals and main group metals. Examples of suitable catalytic metals are silver, platinum, gold, palladium, iron, nickel, cobalt, gallium, indium, ruthenium, rhodium, osmium, iridium, or the like, or a combination including at least one of the foregoing metals. In one embodiment, the catalytic metal consists essentially of silver.

The average catalytic metal particle size may be up to about 50 nanometers. In one embodiment, the average catalytic metal particle size is about 1 nanometer to about 5 nanometers, about 5 to about 10 nanometers, about 10 to about 20 nanometers, about 20 nanometers to about 30 nanometers, about 30 nanometers to about 40 nanometers, or greater than or equal to about 40 nanometers.

The catalytic metals may be present in the second catalyst composition portion in an amount up to about 50 mole percent (mol %). In one embodiment, the catalytic metals are present in the second catalyst composition portion in an amount in a range of from about 0.025 mol % to about 1 mol %, from about 1 mol % to about 5 mol %, from about 5 mol % to about 10 mol %, from about 10 mol % to about 15 mol %, from about 15 mol % to about 20 mol %, from about 20 mol % to about 30 mol %, from about 30 mol % to about 40 mol %, or greater than or equal to about 40 mol %. One exemplary amount of catalytic metal in the second catalyst composition portion is about 1.5 mol %. One exemplary amount of catalytic metal in the second catalyst composition portion is about 5 mol %.

The second catalyst composition portion may be used in an amount of up to about 90 wt %, based upon the total weight of the catalytic composition. In one embodiment, the second catalyst composition portion may be used in an amount in a range of from about 20 wt %, to about 30 wt %, from about 30 wt %, to about 40 wt %, from about 40 wt %, to about 50 wt %, from about 50 wt %, to about 60 wt %, from about 60 wt %, to about 70 wt %, from about 70 wt %, to about 80 wt %, or greater than about 80 wt %, based upon the total weight of the catalytic composition.

In one embodiment, a suitable solvent, a catalytic metal salt and a porous substrate are mixed together in a reaction vessel to produce the second catalyst composition portion. The catalytic metal salt may impregnate pores of the porous substrate by incipient wetness impregnation. The porous substrate may be filtered, washed, dried and calcined to yield the second catalyst composition portion such that the catalytic metal is disposed on a surface of the porous substrate. During the calcination process, the metal salt may reduce to a catalytic metal.

The first catalyst composition portion and the second catalyst composition portion may intimately mix to form the catalytic composition. A synergy may exist between the first catalyst composition portion and the second catalyst composition portion, which may affect the reduction reaction of NOx to nitrogen when compared with other comparative catalyst. The first catalyst composition may facilitate the conversion of long chain hydrocarbons (C₅ to C₉) into short chain hydrocarbons (C₁ to C₄). The short chain hydrocarbons may affect reduction efficiency.

In a method of using the composition, the composition is disposed in the exhaust stream of an internal combustion engine. The internal combustion engine can be present in an automobile or in a locomotive. However, different engines have different exhaust streams, that is, the exhaust stream component makeup differs from one system to another. Component differences may include NOx levels, sulfur presence, and others. In addition, operating parameters may differ. Examples of differing operating parameters may include temperature and flow rate. The catalyst may reduce NOx to nitrogen and oxygen at a desirable rate and at a desirable temperature. The composition may be disposed into the exhaust gas stream either in powdered form or in the form of a monolith.

During operation, the composition can convert the NOx present in an exhaust stream by about 90 weight percent. In one embodiment, the composition can convert the NOx present in an exhaust stream in an amount in a range of from about 10 weight percent to about 20 weight percent, from about 20 weight percent to about 30 weight percent, from about 30 weight percent to about 40 weight percent, from about 40 weight percent to about 50 weight percent, from about 50 weight percent to about 60 weight percent, from about 60 weight percent to about 70 weight percent, or greater than or equal to about 70 weight percent.

The following examples illustrate methods and embodiments in accordance with the invention, and as such should not be construed as imposing limitations upon the claims. Unless specified otherwise, all components are commercially available from common chemical suppliers such as Alpha Aesar, Inc. (Ward Hill, Mass.), Spectrum Chemical Mfg. Corp. (Gardena, Calif.), and the like.

### EXAMPLES

### Example 1

### Method of Making

The composition is manufactured by mixing a first catalyst composition portion including ferrierite with a second catalyst composition portion including 2 wt % silver disposed on an alumina porous substrate. The second catalyst composition portion is mixed with the first catalyst composition portion in a weight ratio of 4:1.

### Example 2

### Testing and Performance

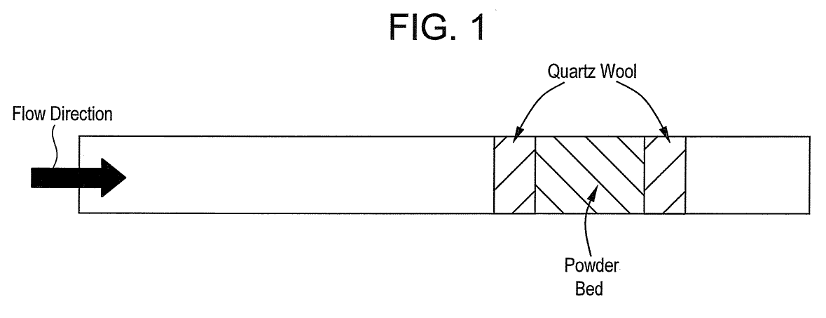

This example is conducted to determine the NOx reducing capabilities of the composition. The composition produced in Example 1 is placed in a furnace between two plugs of quartz wool as shown in the FIG. 1.

A simulated exhaust stream is discharged into the furnace. The flow of the simulated exhaust stream through the furnace is 3 standard liters per minute. The simulated exhaust stream contained nitric oxide in amounts of 475, 610 or 690 parts per million and carbon monoxide in amounts of 250 parts per million. The carbon to nitrogen ratio is set at 6:1. The hydrogen content is 0 parts per million. The water content is set at 7 wt %. The sulfur dioxide and carbon dioxide content is each 0 parts per million. The temperatures in the furnace during the respective experiments are 275, 375 and 430 degrees Celsius. The WSSV (weight specific space velocity) is 674 liters per gram per hour (L/g/hr).

During the flow of the simulated exhaust stream through the furnace a reductant is introduced into the furnace. The reductant included a 1:1 weight mixture of a C8 blend and a C2-C3 blend. The C8 blend included 64 wt % trimethylpentane, 29 wt % toluene and 7 wt % octane. The C2-C3 blend includes 54 wt % ethylene and 46 wt % propylene.

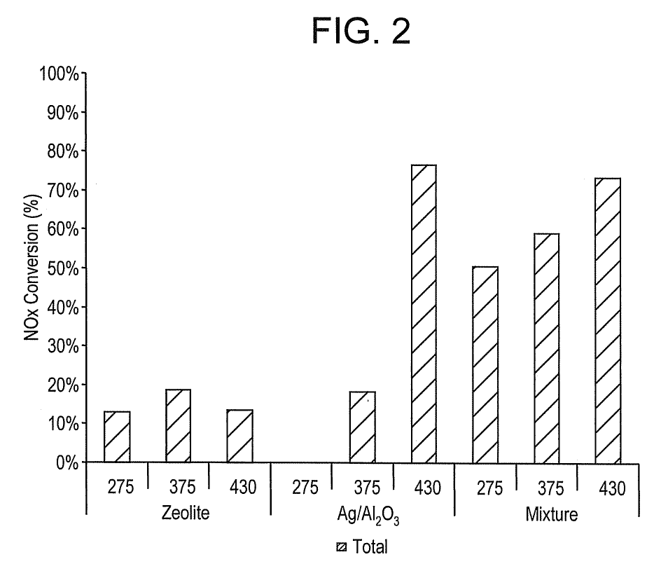

The catalytic composition is tested against two comparative compositions. The first comparative composition contained just the first catalyst composition portion (i.e., just the ferrierite), while the second comparative composition contained just the second catalyst composition portions (i.e., just the silver disposed upon porous alumina). The results for the composition and the two comparative compositions are shown in the FIG. 2. The FIG. 2 is a bar graph that shows NOx conversion at various temperatures in the furnace.

From the results it can be seen that the composition including the mixture of the first catalyst composition portion and the second catalyst composition portion is superior to either the first catalyst composition portion or the second catalyst composition portion. At the respective furnace temperatures of 275, 375 or 430 degrees Celsius, the composition converts an amount of greater than or equal to about 50% of the NOx contained in the simulated exhaust stream. At temperatures of 275 or 375 degrees Celsius the first catalyst composition portion or the second catalyst composition portion showed an ability to convert less than 20 wt % of the NOx present in the simulated exhaust stream. Only at 430 degrees Celsius, did the second catalyst composition portion show an ability to convert about 75 wt % of the NOx present in the simulated exhaust stream.

These results demonstrate the synergistic capabilities of the first catalyst composition portion and the second catalyst composition portion to reduce NOx present in an exhaust stream. The synergy is apparent at lower temperatures of 275 to 375 degrees Celsius.

### Example 3

### Mixture Comparison

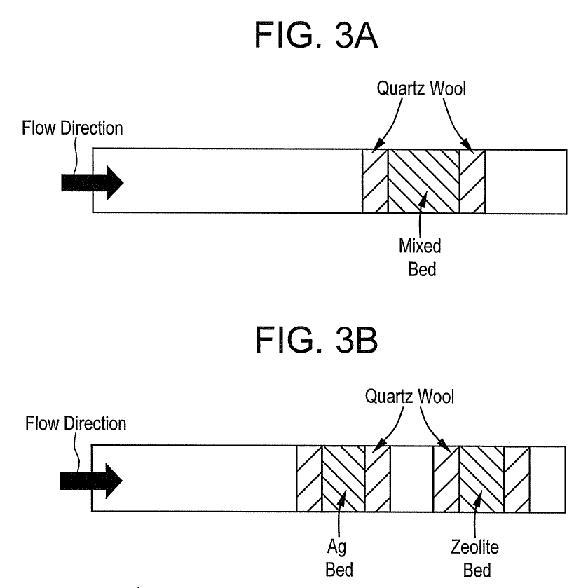

This example is conducted to compare the ability of a first composition (Sample X) in which the first and second catalyst composition portions are intimately mixed together versus the ability of a second material in which first and second catalyst composition portions (Sample Y) are not mixed together with regard to the ability to chemically reduce NOx. The configuration of the furnace is shown in the FIG. 3. As can be seen in the FIG. 3(a), each Sample is tested by placing a single bed containing the composition between two plugs of quartz wool.

When the first catalyst composition portion and the second catalyst composition portion are tested as can be seen in the FIG. 3(b), they are placed in a dual bed configuration between two plugs of quartz wool, with the ferrierite (i.e., first catalyst composition portion) being placed downstream of the silver disposed on the alumina (i.e., the second catalyst composition portion). The remaining test conditions are the same as detailed in the Example 1.

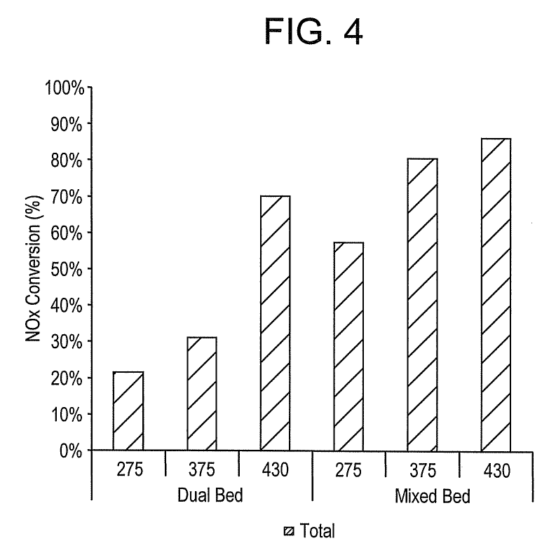

The results are shown in the FIG. 4. The FIG. 4 is a bar graph that shows NOx conversion at the different temperatures for the composition in intimate mixture form (single bed configuration) as well as in the dual bed configuration. From the FIG. 2, it may be seen that at all the temperatures, the composition displayed a superior NOx conversion capability.

### Example 4

This example is conducted to demonstrate the NOx reducing capabilities of the catalytic composition. The example is also conducted to demonstrate the NOx reducing capabilities of the catalytic composition when the first catalyst composition portion and the second catalyst composition portion are used in different weight ratios. The reductants selected for the example 3 are octane, Moctane (which includes 5 wt % of 2,4-dimethylhexane, 3 wt % of 3,4-dimethylhexane, 54 wt % of 2,2,4-trimethylpentane, 10 wt % octane and 29 wt % toluene), C1-C3, which includes methane, ethylene and propylene in amounts of 5500 ppm, 30,900 ppm and 27,500 ppm respectively. A Moctane/C1-C3 blend is the reductant. The weight ratio of Moctane to the C1-C3 is 1:1 based on the carbon present in the exhaust stream.

A simulated exhaust stream having a carbon to nitrogen ratio of 8 is used to determine NOx reduction in the furnace. The respective catalysts are inserted into the furnace in amounts of 25 -36 grams. The nitrogen oxide content in the simulated exhaust gas stream is 600 ppm. The sulfur dioxide content is 1 ppm. The water content is 7 weight percent and the oxygen content is 13 weight percent with the balance being nitrogen. The WSSV (weight specific space velocity) for this example was 67-96 L/g/hr. The results are shown in the Table 3 below.

TABLE 3

| | Reductant | | | | | | | | | | | |
|---|---|---|---|---|---|---|---|---|---|---|---|---|
| | Octane | | | Moctane | | | C1-C3 | | | Moctane/C1-C3 | | |
| Temperature (°C.) | 275 | 325 | 425 | 275 | 325 | 425 | 275 | 325 | 425 | 275 | 325 | 425 |
| Catalyst Composition | | | | | | | | | | | | |
| 2% Ag/Al₂O₃ | 10 | 95 | 60 | 11 | 43 | 83 | 2 | 10 | 29 | 11 | 20 | 50 |
| Ferrierite | 2 | 4 | 12 | 2 | 4 | 10 | 28 | 13 | 5 | 13 | 12 | 11 |
| 2% Ag/Al₂O₃ followed by | 15 | 95 | 41 | 1 | 10 | 30 | 33 | 45 | 46 | 22 | 38 | 50 |
| Ferrierite (dual bed) | | | | | | | | | | | | |
| Ferrierite followed by | 11 | 95 | 60 | 1 | 15 | 35 | 14 | 39 | 48 | 13 | 31 | 47 |
| 2% Ag/Al₂O₃ (dual bed) | | | | | | | | | | | | |
| Mixed 2% Ag/Al₂O₃ and | 0 | 21 | 51 | 0 | 10 | 21 | 15 | 38 | 45 | 20 | 33 | 40 |
| Ferrierite (weight ratio 1:4) | | | | | | | | | | | | |
| Mixed 2% Ag/Al₂O₃ and | 0 | 52 | 60 | 0 | 18 | 43 | 28 | 70 | 70 | 28 | 48 | 53 |
| Ferrierite (weight ratio 2:3) | | | | | | | | | | | | |
| Mixed 2% Ag/Al₂O₃ and | 0 | 95 | 70 | 0 | 29 | 64 | 44 | 88 | 82 | 31 | 65 | 65 |
| Ferrierite (weight ratio 1:1) | | | | | | | | | | | | |
| Mixed 2% Ag/Al₂O₃ and | 0 | 90 | 65 | 0 | 28 | 63 | 43 | 83 | 78 | 28 | 58 | 60 |
| Ferrierite (weight ratio 3:2) | | | | | | | | | | | | |
| Mixed 2% Ag/Al₂O₃ and | 20 | 90 | 74 | 5 | 45 | 78 | 75 | 80 | 75 | 48 | 61 | 65 |
| Ferrierite (weight ratio 4:1) | | | | | | | | | | | | |
| Al₂O₃ | 2 | 5 | 20 | 1 | 2 | 3 | 1 | 2 | 4 | 1 | 2 | 4 |

From the Table 3, the catalytic composition containing the first catalyst composition portion (ferrierite) and the second catalyst composition portion (2 wt % silver on alumina) in a ratio of 1:4 produces superior NOx conversion results at all temperatures when C1-C3 and a Moctane/C1-C3 blend is the reductant.

From the above experiments, the composition can convert the NOx present in an exhaust stream in an amount of up to about 90 weight percent.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A catalytic composition comprising:
a first catalyst composition portion that comprises a zeolite; and
a second catalyst composition portion that comprises a catalytic metal disposed on a surface of a porous inorganic substrate, and the first catalyst composition portion and the second catalyst composition portion form an intimate mixture.

2. The composition as defined in claim 1, wherein the zeolite is zeolite Y, zeolite beta, mordenite, ZSM-5, or a combination comprising at least two of the foregoing.

3. The composition as defined in claim 1, wherein the zeolite is ferrierite.

4. The composition as defined in claim 3, wherein the ferrierite has a silicon to aluminum weight ratio in a range of from about 10 to about 30.

5. The composition as defined in claim 3, wherein the ferrierite has a surface area in a range of from about 200 m²/gm to about 500 m²/gm.

6. The composition as defined in claim 1, wherein the first catalyst composition portion is present in an amount in a range of from about 20 to about 80 weight percent, based upon the weight of the catalytic composition.

7. The composition as defined in claim 1, wherein the catalytic metal is gold, palladium, cobalt, nickel, iron, or a combination comprising at least one of the foregoing metals.

8. The composition as defined in claim 1, wherein the catalytic metal is silver.

9. The composition as defined in claim 1, wherein the catalytic metal is present in the second catalyst composition portion in an amount in a range of from about 0.025 mole percent to about 50 mole percent.

10. The composition as defined in claim 1, wherein the porous inorganic substrate comprises an inorganic oxide, inorganic carbide, inorganic nitride, inorganic boride, inorganic oxycarbide, inorganic oxynitride, or a combination comprising at least one of the foregoing.

11. The composition as defined in claim 9, wherein the porous inorganic substrate is a metal oxide, a metal carbide, a metal nitride, a metal boride, a metal oxycarbide, a metal oxynitride, or a combination comprising at least one of the foregoing.

12. The composition as defined in claim 1, wherein the porous inorganic substrate comprises silica, alumina, titania, zirconia, ceria, manganese oxide, zinc oxide, iron oxide, calcium oxide, manganese dioxide, silicon carbide, titanium carbide, tantalum carbide, tungsten carbide, hafnium carbide, silicon nitrides, titanium nitride, lanthanum boride, chromium borides, molybdenum borides, tungsten boride, or a combination comprising at least two of the foregoing porous inorganic substrates.

13. The composition as defined in claim 1, wherein the porous inorganic substrate is alumina.

14. The composition as defined in claim 1, wherein the composition is a monolith.

15. The composition as defined in claim 1, wherein the composition reduces the nitrogen oxide concentration in an exhaust gas stream in contact therewith at a temperature in a range of from about 200 to about 500 degrees Celsius.

16. The composition as defined in claim 1, wherein the composition reduces the nitrogen oxide concentration in an exhaust gas stream in contact therewith by an amount of up to 90 weight percent at a temperature in a range of from about 200 degrees Celsius to about 500 degrees Celsius.

17. A method, comprising:
mixing a first catalyst composition portion with the second catalyst composition portion to form a catalytic composition; the first catalyst composition portion comprising a zeolite and the second catalyst composition portion comprising a metal disposed upon a porous substrate.

18. The method as defined in claim 17, further comprising blending a porous substrate with a solution of a metal salt to form a catalytic mixture; and calcining the catalytic mixture to form a second catalytic composition portion.

19. The method as defined in claim 17, wherein the blending of the porous substrate with the metal salt solution comprises introducing the metal salt into pores of the porous substrate by incipient wetness.

20. The method as defined in claim 18, wherein the calcining is conducted at a temperature in a range of from about 600 degrees Celsius to about 700 degrees Celsius.

21. The method as defined in claim 17, further comprising contacting the catalytic composition with an exhaust gas stream that comprises a reactive chemical species to affect a concentration level of the reactive chemical species in the exhaust gas stream.

22. The method as defined in claim 17, wherein the reactive chemical species is a nitrogen oxide.

23. The method as defined in claim 17, wherein the affecting a concentration level of the reactive species comprising chemically reducing the reactive species to a relatively less reactive species.

24. The method as defined in claim 23, wherein the concentration level of the reactive species is reduced by an amount in a range of about 10 weight percent to about 90 weight percent.
